(19) United States
(12) Patent Application Publication
(10) Pub. No.: US 2007/0202980 A1
(43) Pub. Date: Aug. 30, 2007

(54) Elevator traction machine

(76) Inventors: Jae-Young Hur, Incheon (KR); Rak-Chun Baek, Seoul (KR)

Correspondence Address: MORGAN LEWIS & BOCKIUS LLP, 1111 PENNSYLVANIA AVENUE NW, WASHINGTON, DC, 20004, US

(21) Appl. No.: 10/585,737

(22) PCT Filed: Jun. 29, 2004
(86) PCT No.: PCT/KR04/01576

§ 371 Date: Apr. 12, 2007

(30) Foreign Application Priority Data
Dec. 10, 2003 (KR) 20-2003-0038537

(51) Int. Cl. F16H 48/06

(52) U.S. Cl. 475/154

(57) ABSTRACT

The present invention relates to an elevator traction machine, and more particularly, to an elevator traction machine, wherein a plurality of planetary gears are coupled to be circumscribed and engaged with a sun gear formed at one end of a driven shaft in order to reduce high speed rotation transmitted from a driving motor and to wind wires on a sheave, and pinions formed at the other sides of the planetary gears are circumscribed and engaged with a plurality of other planetary gears or a fixed sun gear so that planetary gears just before the fixed sun gear can be rotated together with a flange, thereby obtaining reduction effects for a gear ratio among the sun gears, pinions and planetary gears, and noise/vibration-reducing effects and large rotational force-transmitting effects due to formation of the gears out of helical gears.

### TECHNICAL FIELD

The present invention relates to an elevator traction machine, and more particularly, to an elevator traction machine, wherein a plurality of planetary gears are coupled to be circumscribed and engaged with a sun gear formed at one end of a driven shaft in order to reduce high speed rotation transmitted from a driving motor and to wind wires on a sheave, and pinions formed at the other sides of the planetary gears are circumscribed and engaged with a plurality of other planetary gears or a fixed sun gear so that planetary gears just before the fixed sun gear can be rotated together with a flange, thereby obtaining reduction effects for a gear ratio among the sun gears, pinions and planetary gears, and noise/vibration-reducing effects and large rotational force-transmitting effects due to formation of the gears out of helical gears.

### BACKGROUND ART

Generally, an elevator is provided with a traction machine at an upper portion of a main frame for defining a hoistway in which an elevator car connected to a traction rope is adapted to vertically carry passengers or goods.

Here, the traction machine is an apparatus for driving the elevator car by rotating a sheave around which the traction rope is wound. The traction machine comprises a driving motor for providing a rotational force, the sheave for winding the traction rope connected to the elevator car so that the elevator car can vertically move, and an electric brake for shutting off a main circuit of the motor and simultaneously stopping the rotation of the sheave upon operating and stopping of the car.

To operate the elevator with the traction machine, the driving motor should be controlled by means of commands from a control unit in a series of motions of the car, including starting, acceleration, travel, deceleration, floor landing, and stopping.

Meanwhile, the cylindrical sheave is fixedly installed on an extension of a rotational shaft of the driving motor. An outer peripheral surface of the sheave is formed with a rope groove in which the wire traction rope is caught, so that the traction rope is vertically moved while being caught in the rope groove and wound by the sheave, thereby converting the rotational motion of the motor into a linear motion of the car without slippage of the traction rope on the sheave under the load of the car.

Further, when the car is stopped, the car cannot be smoothly stopped due to the deadweight of the car and an inertial force resulting from the rotation of the motor. Therefore, breaking should be made by the electric break and a reducer to achieve precision braking.

As for a traction machine commonly used in conventional elevators, a worm gear type traction machine in which deceleration is made by worm gears is widely used. Since the output efficiency of the worm gear type traction machine is poor on the order of about 68% to 75%, power loss is large. Accordingly, there is being developed a traction machine that can maximize energy saving effects and output efficiency by minimizing power required for the worm gear type traction machine, minimize noise and vibrations, and minimize an installation space while improving stability and durability.

An elevator traction machine for improving the output efficiency of such a worm gear type traction machine is disclosed in Korean Utility Model Registration No. 314359 filed in the name of this applicant. FIGS. 10 and 11 are an exploded perspective view of the elevator traction machine and a sectional view showing an assembled state thereof, respectively.

The elevator traction machine shown in FIGS. 10 and 11 comprises a driving unit for providing a rotational motion to a sheave 228 through a driving shaft of a driving motor 201 and a driven shaft 209 that is connected to the driving shaft and has oppositely offset eccentric shafts formed integrally therewith and bearings 210 formed on outer peripheral surfaces of the eccentric shafts; a braking unit having a block brake device for controlling a rotational motion of a brake drum 203 coupled to the driving shaft; a reducer unit including cycloid gears 211 and 213 each of which has a central hole for coupling with one of the eccentric shafts, a plurality of holes for receiving power-transmitting pins formed equidistantly on a circumference with a predetermined radius, and cycloid teeth on an outer periphery thereof, a pin gear 222 formed by means of insertion of pins 223 along an inner periphery of a flange thereof so that the cycloid gears 211 and 213 are inscribed to and engaged with the pin gear 222, and the power-transmitting pins 220 inserted into the holes of the cycloid gears 211 and 213 so that the cycloid gears 211 and 213 rotate together with hollow shafts 219 and 229; the sheave 228 that is coupled to the flange of the pin gear 222 and has a rope groove in which a wire rope is caught; and a base 225 for fixedly supporting the driving unit, the braking unit and the reducer unit.

In the elevator traction machine, when the cycloid gears 211 and 213 coupled to the driven shaft 209 formed with the oppositely offset eccentric shafts are installed and rotated inside of the pin gear 222 serving as an internal tooth gear, the cycloid gears 211 and 213 with the number of teeth (N−1) smaller by one than the number of teeth (N) of the pin gear 222 slidably come into contact with rollers 224 of the pin gear 222. At this time, noise and vibrations occur periodically, resulting in difficulty in operating an elevator silently. Further, there is a problem in that the pins 223 become weak due to impacts periodically produced when the cycloid gears 211 and 213 come into contact with the pin gear 222. Moreover, since it is difficult to manufacture the cycloid gears 211 and 213 using universal gear manufacturing equipment, there is a problem in that production costs increase.

### DISCLOSURE OF INVENTION

Accordingly, the present invention is conceived to solve the aforementioned problems. An object of the present invention is to provide a planetary gear type reducer constructed by sequentially engaging a sun gear, a plurality of planetary gears and a plurality of pinions with one another to reduce high speed rotation to low speed rotation and output the low speed rotation through a sheave, and ultimately, to provide an elevator traction machine using the reducer in which speed reduction is achieved by means of a gear ratio between the sun gear and the planetary gears by causing the plurality of planetary gears to be rotated while being circumscribed and engaged with the sun gear formed at one end of a driven shaft coupled to a driving shaft, rotational shafts for the planetary gears are rotated together with the sheave when the planetary gears revolve around the sun gear by coupling the rotational shafts for the planetary gears to a cover integrally formed with or separately coupled to the sheave, and the sun gear, planetary gears and pinions are constructed of helical gears to reduce noise and transmit a larger rotational force when the plurality of planetary gears are engaged and rotated with the sun gear formed on the driven shaft.

The object of the present invention is achieved by an elevator traction machine, comprising a driving unit for transmitting a driving force from a driving motor, including a driving shaft of the driving motor and a driven gear having a first sun gear formed at the other end of a driven shaft coupled to the driving shaft; a braking unit including a brake drum in the form of a coupling for connecting the driving shaft to one end of the driven shaft, and block brakes for controlling a rotational motion while coming into close contact with an outer peripheral surface of the brake drum; a reducer unit constructed such that a planetary gear of each of one or more transmission gears is rotated while being circumscribed and engaged with the first sun gear of the driven gear, a second sun gear of a fixed gear is stationary in a state where it is circumscribed and engaged with a planetary pinion of each of the transmission gears, and a spline of the fixed gear is fixedly inserted into a spline hole formed at the center of a fixing cover attached to a bracket; a rotating unit including a flange which a supporting shaft of the fixed gear penetrates through and is supported by at the center thereof and which a planetary gear shaft of each of the transmission gears penetrates through and is supported by at a circumferential portion with a radius R therein, a one-side cover which the driven shaft of the driven gear penetrates through and is supported by and which one end of the planetary gear shaft is inserted into and fixed to, and an other-side cover which the other end of the supporting shaft of the fixed gear penetrates through and is fixed to and which the other end of the planetary gear shaft is inserted into and fixed to, thereby rotating the covers as the planetary gear revolves; a sheave which is formed to be coupled to an outer periphery of the flange and of which an outer peripheral surface is provided with rope grooves in which wire ropes are caught; and a supporting unit for fixedly supporting the driving unit, the braking unit and the rotating unit with a plurality of brackets and bearings.

The object of the present invention is also achieved by an elevator traction machine comprising a driving unit for transmitting a driving force from a driving motor, including a driving shaft of the driving motor and a driven gear having a first sun gear formed at the other end of a driven shaft coupled to the driving shaft; a braking unit including a brake drum in the form of a coupling for connecting the driving shaft to one end of the driven shaft, and block brakes for controlling a rotational motion while coming into close contact with an outer peripheral surface of the brake drum; a reducer unit constructed such that a first planetary gear of each of one or more first transmission gears is rotated while being circumscribed and engaged with the first sun gear of the driven gear, a second planetary gear of each of one or more second transmission gears is rotated while being circumscribed and engaged with a second planetary pinion of each of the first transmission gears, a third sun gear of a fixed gear is stationary in a state where it is circumscribed and engaged with a third planetary pinion of each of the second transmission gears, and a spline of the fixed gear is fixedly inserted into a spline hole formed at the center of a fixing cover attached to a bracket; a rotating unit including a flange which a supporting shaft of the fixed gear penetrates through and is supported by at the center thereof, which a first planetary gear shaft of each of the first transmission gears penetrates through and is supported by at a circumferential portion with a first radius R1 therein, and which a second planetary gear shaft of each of the second transmission gears penetrates through and is supported by at a circumferential portion with a second radius R2 therein, a one-side cover which the driven shaft of the driven gear penetrates through and is supported by, which one end of the first planetary gear shaft is inserted into and fixed to, and which one end of the second planetary gear shaft is inserted into and fixed to, and an other-side cover which the other end of the supporting shaft of the fixed gear penetrates through and is fixed to and which the other end of the second planetary gear shaft is inserted into and fixed to, thereby rotating the covers as the planetary gears revolve; a sheave which is formed to be coupled to an outer periphery of the flange and of which an outer peripheral surface is provided with rope grooves in which wire ropes are caught; and a supporting unit for fixedly supporting the driving unit, the braking unit and the rotating unit with a plurality of brackets and bearings.

Preferably, an inward side of the cover is formed on a circumference with the radius R with a planetary gear shaft recess into which one end of the planetary gear shaft is inserted, and at the center thereof with a driven-shaft hole through which the one end of the driven shaft penetrates; and an inward side of the cover is formed on a circumference with the radius R with a planetary gear shaft recess into which the other end of the planetary gear shaft is inserted, and at the center thereof with a fixed-gear shaft hole through which the other end of the supporting shaft penetrates. Alternatively, an inward side of the cover is formed on circumferences with the first and second radii R1 and R2 with first and second planetary gear shaft recesses into which one ends of the first and second planetary gear shafts are inserted, and at the center thereof with a driven-shaft hole through which the one end of the driven shaft penetrates; and an inward side of the cover is formed on a circumference with the second radius R2 with a second planetary gear shaft recess into which the other end of the second planetary gear shaft is inserted, and at the center thereof with a fixed-gear shaft hole through which the other end of the supporting shaft of the fixed gear penetrates.

More preferably, the sheave is formed integrally with the outer periphery of the flange.

Further, the planetary gear may be coupled to an outer peripheral surface of one side of the planetary gear shaft by means of a key, and the planetary pinion may be formed on an outer peripheral surface of the other side of the planetary gear shaft. The planetary gear may be coupled to one side of the planetary gear shaft of one of the transmission gears by means of a power lock.

Moreover, the first planetary gear may be coupled to an outer peripheral surface of one side of the first planetary gear shaft by means of a key, and the second planetary pinion may be formed on an outer peripheral surface of the other side of the first planetary gear shaft; and the second planetary gear may be coupled to an outer peripheral surface of one side of the second planetary gear shaft by means of a key, and the third planetary pinion may be formed on an outer peripheral surface of the other side of the second planetary gear shaft. The first planetary gear may be coupled to one side of the first planetary gear shaft of one of the first transmission gears by means of a power lock.

In addition, the driven gear, the planetary gear(s) and the fixed gear may be formed of helical gears with a helix angle of 15 to 25 degrees.

### BRIEF DESCRIPTION OF DRAWINGS

FIG. 1 is an exploded perspective view of an elevator traction machine according to a first embodiment of the present invention.

FIG. 2 is a sectional view showing an assembled state of the elevator traction machine according to the first embodiment of the present invention.

FIG. 3 is a sectional view showing a gear engagement state taken along line A-A of FIG. 2.

FIG. 4 is a front view of the elevator traction machine according to the first embodiment of the present invention.

FIG. 5 is a sectional view showing an assembled state of an elevator traction machine according to a second embodiment of the present invention.

FIG. 6 is an exploded perspective view of an elevator traction machine according to a third embodiment of the present invention.

FIG. 7 is a sectional view showing an assembled state of the elevator traction machine according to the third embodiment of the present invention.

FIG. 8 is a sectional view showing a gear engagement state taken along line B-B of FIG. 7.

FIG. 9 is a sectional view showing an assembled state of an elevator traction machine according to a fourth embodiment of the present invention.

FIG. 10 is an exploded perspective view of a conventional elevator traction machine.

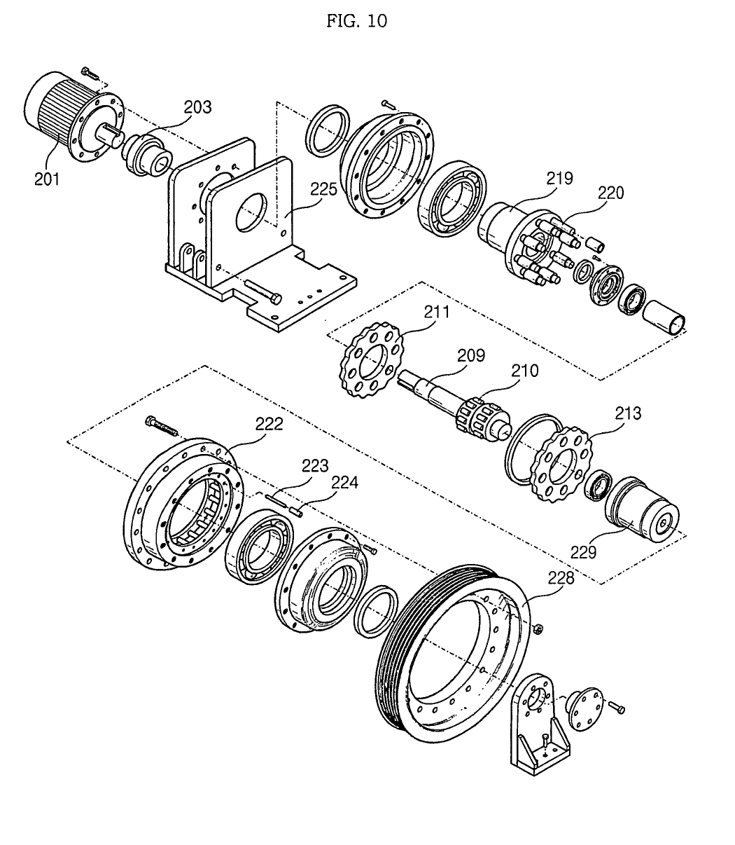

FIG. 11 is a sectional view showing an assembled state of the conventional elevator traction machine.

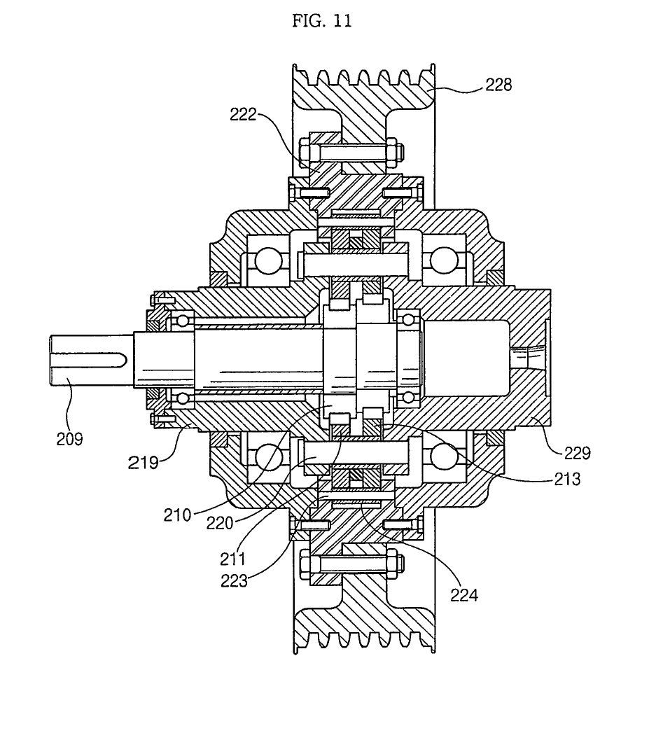

### BEST MODE FOR CARRYING OUT THE INVENTION

Hereinafter, preferred embodiments of the present invention will be described in detail with reference to accompanying drawings.

For the sake of easy understanding in the following description of the constitution and embodiments of an elevator traction machine according to the present invention, a side or end where a driving motor is located is defined as “one side or end,” and another side or end where an end cover is coupled is defined as “the other side or end.”

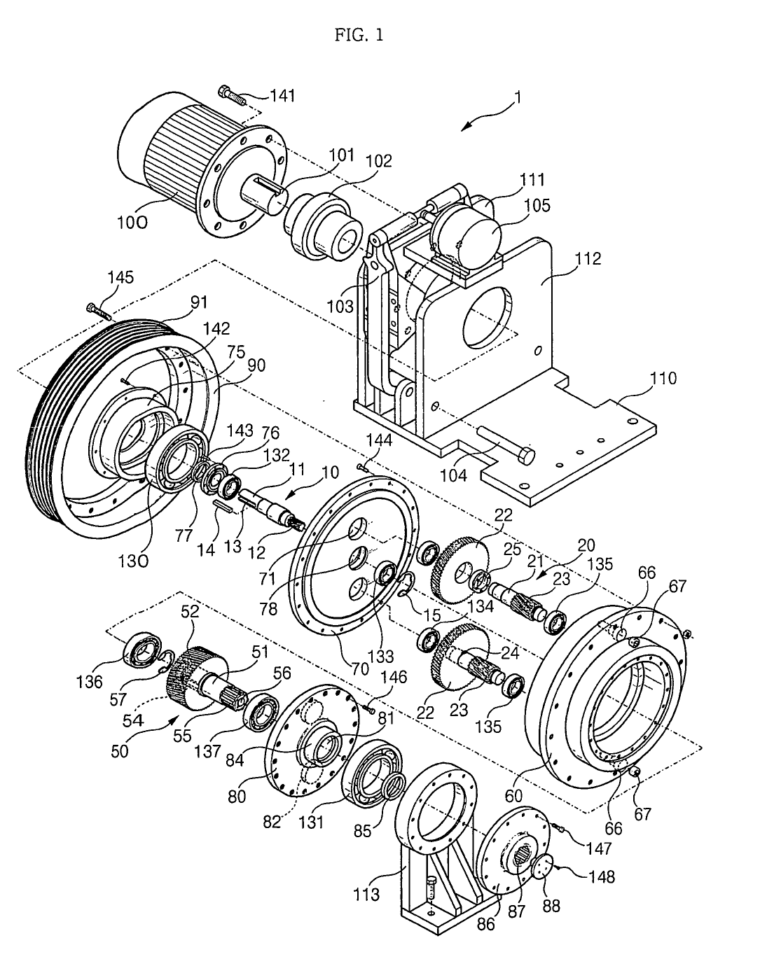

FIGS. 1 to 4 are an exploded perspective view, a sectional view showing an assembled state, a sectional view showing a gear engagement state, and a front view in an elevator traction machine according to a first embodiment of the present invention, respectively.

The elevator traction machine 1 according to the first embodiment of the present invention comprises a driving unit, a braking unit, a reducer unit, a rotating unit, a sheave 90 and a supporting unit. Particularly, the reducer unit is constructed such that the sheave 90 is rotated while two-stage speed reduction is achieved by means of a gear ratio among sun gears 12 and 52, planetary gears 22 and pinions 23.

The driving unit is adapted to transmit a driving force from a driving motor 100 to a transmission unit, and comprises a driving shaft 101 of the driving motor 100 and a driven gear 10 coupled to the driving shaft 101. A driven shaft 11 of the driven gear 10 is formed, at the other end thereof, with the first sun gear 12 to be engaged with the plurality of gears constituting the reducer unit.

The braking unit comprises a brake drum 102 in the form of a coupling for connecting the driving shaft 101 to one end of the driven shaft 11, and block brakes 103 for controlling a rotational motion while coming into close contact with an outer peripheral surface of the brake drum 102. The block brakes 103 are mechanically connected to a general hydraulic device 105 and general brake shoes.

The reducer unit is to reduce the rotational speed of the driven gear 10 rotating at high speed and to rotate the sheave 90 at low speed. In the reducer unit, the driven gear 10, a plurality of transmission gears 20 and a fixed gear 50 are engaged with one another in a state where they are circumscribed with one another. Specifically, the planetary gear 22 of each of one or more transmission gears 20 is rotated while being circumscribed and engaged with the first sun gear 12 of the driven gear 10. The second sun gear 52 of the fixed gear 50 is stationary in a state where it is circumscribed and engaged with the planetary pinions 23 of the transmission gears 20. A spline 55 of the fixed gear 50 is fixedly inserted into a spline hole 87 formed at the center of a fixing cover 86 attached to a bracket 113.

The rotating unit is to rotate a one-side cover 70 and an other-side cover 80 as the planetary gears 22 revolve, and simultaneously to rotate a flange 60 interposed between and coupled to the covers 70 and 80. In the rotating unit, a supporting shaft 51 of the fixed gear 50 penetrates through and is supported at the center of the flange 60, and a planetary gear shaft 21 of each transmission gear 20 penetrates through and is supported at a circumferential portion with a radius R in the flange 60. The driven shaft 11 of the driven gear 10 penetrates through and is supported by the cover 70, and one end of the planetary gear shaft 21 is inserted into and fixed to the cover 70. The other end of the supporting shaft 51 penetrates through and is fixed to the cover 80, and the other end of the planetary gear shaft 21 is also inserted into and fixed to the cover 80.

The sheave 90 is formed to be coupled to an outer periphery of the flange 60, and an outer peripheral surface of the sheave is provided with rope grooves 91 in which wire ropes are caught.

The supporting unit is to fixedly support the driving unit, the braking unit and the rotating unit with a plurality of brackets 111, 112 and 113 and bearings 130 to 137.

The respective components of the elevator traction machine according to the first embodiment of the present invention will be described below with reference to FIG. 1.

A general motor capable of reversibly rotating according to switching of electrodes is used for the driving motor 100. The driving motor 100 is fixed to the bracket 111 vertically formed at a side of a base 110 by using bolts 141 that penetrate through holes of a flange integrally formed at a front end of the driving motor. The driving shaft 101 of the driving motor 100 is coupled to the brake drum 102 in the form of a coupling by inserting a key into a keyway formed at an outer peripheral surface of the driving shaft 101.

On both sides of the outer peripheral surface of the brake drum 102, the brake shoes (brake blocks) that are braking means of the general block brakes 103 are hingedly fixed at their lower ends using pins 104, so that the brakes shoes (not shown) come into close contact with the brake drum 102 to perform the control and braking of a rotational motion according to an operation of the hydraulic device 105.

The driven shaft 11 to be connected to the her end of the brake drum 102 is formed with a keyway 13 on an outer peripheral surface of one end thereof to establish the connection thereof to the brake drum 102. The driven shaft is coupled integrally to the brake drum by inserting a key into the keyway 13. The other end of the driven shaft 11 is formed with the first sun gear 12 to be rotated while being engaged with the planetary gears 22 of the transmission gears 20.

The driven gear 10 connected to the driving shaft 101 of the driving motor 100 is rotated in a state where the driven shaft 11 is inserted into a driven-shaft hole 78 formed at the center of the cover 70 and both ends of the driven shaft are supported by the bearings 132 and 133. Outside the bearing 133 coupled to the other side of the driven shaft 11 of the driven gear 10, a snap ring 15 is in close contact with an inner peripheral surface of the driven-shaft hole 78 to prevent the driven shaft 11 from advancing due to thrust of the first sun gear 12 upon rotation of the driven shaft 11.

In each of the transmission gears 20 that revolves along a circumference with the radius R around the driven shaft 11 of the driven gear 10 while rotating through engagement with the driven gear 10, the planetary gear 22 is coupled to an outer peripheral surface at one side of the planetary gear shaft 21 using a key 24 or a power lock 25 such that the planetary gear is circumscribed with the first sun gear 12 of the driven gear 10. The planetary pinion 23 is formed on an outer peripheral surface at the other side of the planetary gear shaft 21. In case of the elevator traction machine 1 according to the first embodiment of the present invention, two planetary gears 22 are positioned diametrically at an angular interval of 180 degrees while being spaced apart by the radius R from the driven shaft 11. Further, the planetary gear shaft 21 is rotated in a state where both ends thereof are inserted into planetary gear shaft recesses 71 and 82 formed in the covers 70 and 80 and are supported by the bearings 134 and 135 in the recesses. The planetary gear shaft 21 between the planetary gear 22 and the planetary pinion 23 penetrates through and is disposed in a planetary gear shaft hole 63 formed in the flange 60 so that the flange 60 can be rotated together therewith upon revolution of the planetary gear shaft 21. Here, the power lock 25 is interposed between the planetary gear shaft 21 and the planetary gear 22 to ensure precise alignment of the engagement of the first sun gear 12 with the planetary gear 22 in a state where the first sun gear 12 is placed. When teeth of the planetary pinion 23 of each of the transmission gears 20 are exactly engaged with teeth of the second sun gear 52 by adjusting the planetary gear shaft 21, the power lock 25 coupled to the planetary gear shaft 21 is expanded so that the planetary gear 22 can be firmly coupled to the planetary gear shaft 21.

Further, the second sun gear 52 of the fixed gear 50 that is engaged with the transmission gear 20 in a stationary state to revolve the transmission gear 20 is coupled through a key 54 to an outer peripheral surface of one end of the supporting shaft 51 so that the second sun gear 52 is circumscribed with the planetary pinion 23 of the transmission gear 20. A snap ring 57 is coupled to one side of the second sun gear 52 to prevent the second sun gear 52 from escaping in a direction of the one side due to thrust upon rotation thereof. The spline 55 is formed on an outer peripheral surface of the other end of the supporting shaft 51, and an air vent 56 is formed to axially penetrate through a central portion of the supporting shaft 51 in order to discharge gas or vapor produced due to increases in temperature of the reducer unit or inject a lubricant. A portion just before an outlet of the air vent 56 is formed with female threads for engagement of an additional air-discharging element (not shown). One end of the supporting shaft 51 is rotated in a state where it is inserted into a supporting-shaft hole 61 of the flange 60 and supported by the bearing 136 therein. The other side of the supporting shaft 51 with respect to the second sun gear 52 penetrates through a fixed-gear shaft hole 81 formed at the center of the cover 80 and is supported by the bearing 137 therein.

Further, a fixing cover 86 for fixing the spline 55 formed at the other end of the supporting shaft 51 to revolve the planetary pinion 23 that is circumscribed and engaged with the second sun gear 52 is formed, at the center thereof, with the spline hole 87 into which the spline 55 is inserted. A plurality of holes are circumferentially formed along an outer periphery of the fixing cover 86 so that the fixing cover 86 is fixed to the other side of the bracket 113 by means of bolts 147.

The flange 60 through which the planetary gear shaft 21 of the transmission gear 20 penetrates and which rotates upon revolution of the planetary gear shaft 21 has the supporting-shaft hole 61 formed at the center thereof so that the one end of the supporting shaft 51 is inserted into the supporting-shaft hole and supported by the bearing 136 therein. The planetary gear shaft hole 63 through which the planetary gear shaft 21 penetrates is formed at a position on the flange spaced apart by the radius R from the center of the flange 60. Another planetary gear shaft hole 63 through which another planetary gear shaft 21 penetrates is formed at a position on the flange diametrically opposite to (spaced apart by 180 degrees from) the above position. Therefore, the flange 60 has the supporting-shaft hole 61 for receiving the supporting shaft 51 at the center thereof, and the two planetary gear shaft holes 63 on a circumference with the radius R. Moreover, a plurality of holes are circumferentially formed along the outer periphery of the flange 60 so that a side of the sheave 90 is coupled to the flange by means of bolts 145. Upper and lower portions of the outer periphery of the flange 60 are axially provided with oil discharge ports 66 to communicate with a space defined when the cover 70 is coupled to the flange 60. The oil discharge ports 66 are closed by inserting closures 67 in the form of a sunken screw thereinto.

The cover 70 for defining a space in which the planetary gears 22 revolve when the cover is coupled to the outer periphery of one side of the flange 60 and for supporting the driven shaft 11 penetrating through the cover is provided with a protruding boss 74 at the center of one side of the cover. The driven-shaft hole 78 is formed at the center of the boss 74 so that the driven shaft 11 can be inserted thereinto. An inward side of the cover 70 is formed with the planetary gear shaft recesses 71 into which one ends of the planetary gear shafts 21 are inserted, at a position spaced apart by the radius R from the center thereof and a position diametrically opposite to (spaced apart by 180 degrees from) the above position. A plurality of holes are circumferentially formed along an outer periphery of the cover 70 so that the outer periphery of the one side of the flange 60 can be coupled thereto by means of the bolts 144.

The cover 80 for defining a space in which the planetary pinions 23 revolve when the cover is coupled to the outer periphery of the other side of the flange 60 and for supporting the supporting shaft 51 penetrating through the cover is provided with a protruding boss 84 at the center of the other side of the cover. The fixed-gear shaft hole 81 is formed at the center of the boss 84 so that the supporting shaft 51 can be inserted thereinto. An inward side of the cover 80 is formed with the planetary gear shaft recesses 82 into which the other ends of the planetary gear shafts 21 are inserted, at a position spaced apart by the radius R from the center thereof and a position diametrically opposite to (spaced apart by 180 degrees from) the above position. A plurality of holes are circumferentially formed along an outer periphery of the cover 80 so that the outer periphery of the other side of the flange 60 can be coupled thereto by means of bolts 146.

The outer peripheral surface of the sheave 90 that is integrally coupled to and rotated with the outer periphery of the flange 60 is formed with the equidistant rope grooves 91 in which the plurality of wire ropes are caught. An outer periphery of the sheave 90 is provided with holes into which the bolts 145 are inserted, at positions corresponding to the holes formed along the outer periphery of the flange 60 so that the flange 60 and the sheave 90 can be coupled to each other by means of the bolts 145.

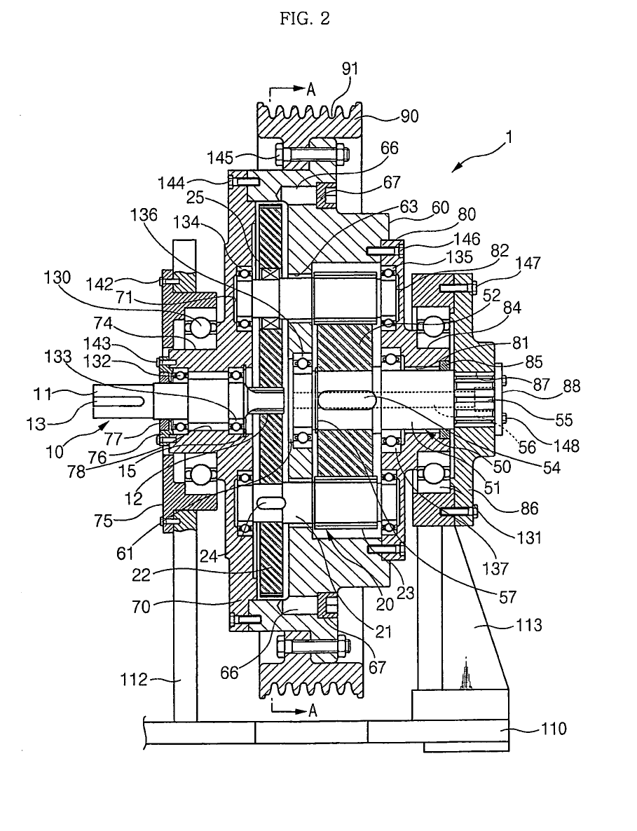

A process of coupling the aforementioned components to one another will be described below in greater detail with reference to FIGS. 1 and 2.

The block brakes 103 adapted to contract inwardly or expand outwardly according to the operation of the hydraulic device 105 are first disposed to face each other outside the brake drum 102 between the brackets 111 and 112 vertically formed at one side of the base 110. Then, the lower ends of the block brakes 103 are fixed by means of the pins 104, thereby completing the braking unit. In the state where the brake drum 102 is positioned between the brackets 111 and 112 formed at the one side of the base 110, the driving shaft 101 of the driving motor 100 is inserted into and coupled through the key to one side of the brake drum 102. The flange of the driving motor 100 is fixed to one side of the bracket 111 of the base 110 by means of the bolts 141.

In a state where the second sun gear 52 is coupled through the key 54 and fixed through the snap ring 57 to one side of the supporting shaft 51, the other side of the supporting shaft 51 is inserted into the fixed-gear shaft hole 81 formed at the center of the cover 80 to be supported by the bearing 137 therein. The other sides of the planetary gear shafts 21 to which the planetary gears 22 have not yet been coupled are inserted into the two planetary gear shaft recesses 82 formed in the cover 80 to be supported by the bearings 135, respectively. At this time, the planetary pinions 23 formed at the outer peripheral surfaces of the other sides of the planetary gear shafts 21 are placed at the positions spaced apart through 180 degrees from each other and are circumscribed with the second sun gear 52 so that they can be supported parallel with the supporting shaft 51.

When the supporting shaft 51 and the planetary gear shaft 21 are fixed to and supported by the cover 80, the flange 60 is coupled to the cover 80. At this time, the planetary gear shafts 21 are passed through the planetary gear shaft holes 63 formed at the positions spaced apart by the radius R from the center of the flange 60, and the one end of the supporting shaft 51 is inserted into the supporting-shaft hole 61 formed at the center of the flange 60 to be supported by the bearing 136. Then, the bolts 146 are inserted into the plurality of holes formed at the outer periphery of the cover 80 to couple the cover 80 to the flange 60. At this time, the coupling of the cover 80 to the flange 60 defines the space therebetween in which the planetary gears 22 revolve.

Once the flange 60 has been coupled to the cover 80, the planetary gears 22 are coupled to portions of the planetary gear shafts 21 exposed toward the one side of the flange 60. At this time, one of the two planetary gears 22 is coupled through the insertion of the key 24 and the other is coupled by interposing the power lock 25 and expanding the power lock 25 when the teeth of the planetary pinions 23 and the second sun gear 52 are exactly engaged with one another by rotating the planetary gear shafts 21 forward or rearward.

Meanwhile, the cover 70 to be coupled to the one side of the flange 60 that has been integrally coupled to the cover 80 receives the driven shaft 11 inserted into the driven-shaft hole 78 formed at the center thereof to be supported by the bearings 132 and 133. A seal holder 76 is fitted outside the bearing 132 that supports one side of the driven shaft 11 and fixed by means of bolts 143, and an oil seal 77 is then fitted into and seated in a groove of the seal holder 76. Outside the bearing 133 supporting the other side of the driven shaft 11, the snap ring 15 is installed at an inner peripheral surface of the driven-shaft hole 78 to prevent the driven shaft 11 from advancing upon rotation of the driven shaft 11. When the driven shaft 11 is inserted into the cover 70, the cover 70 is coupled to the one side of the flange 60. At this time, the one end of each of the planetary gear shafts 21 with the bearing 134 coupled to the outer peripheral surface thereof is inserted into one of the two planetary gear shaft recesses 71 formed in the cover 70 so that the planetary gear shaft 21 can be supported by the bearing 134 within the planetary gear shaft recess 71.

When the rotating unit is completed by coupling the covers 70 and 80 to the both sides of the flange 60 as described above, the sheave 90 is integrally coupled to the outer periphery of the flange 60 by means of the bolts 145.

A supporting cover 75 is inserted on one side of the bracket 112 into a hole of the bracket 112 vertically formed on the base 110 and is then fixed thereto using bolts 142. The bearing 130 is coupled to an outer peripheral surface of the boss 74 of the cover 70 of the rotating unit and the boss is then inserted to be in contact with an inner peripheral surface of the supporting cover 75 so that one end of the rotating unit can be supported by the bearing 130. At the same time, a portion of the driven shaft 11 protruding toward one side of the rotating unit is inserted into the other side of the brake drum 102 and the key 14 is fitted into the keyway 13 formed on the outer peripheral surface of the driven shaft 11, thereby coupling the driven shaft 11 to the driving shaft 101.

The bearing 131 is coupled to an outer peripheral surface of the boss 84 of the cover 80 of the rotating unit and the bracket 113 is fitted around the boss with the beating coupled thereto so that the other end of the rotating unit can be supported by the bracket. To prevent leakage of oil around the supporting shaft 51, an oil seal 85 is fitted between an inner peripheral surface of the other end of the cover 80 and an outer peripheral surface of the supporting shaft 51. To fix the spline 55 of the supporting shaft 51 protruding toward the other side of the rotating unit, the fixing cover 86 formed with the spline hole 87 at the center thereof is coupled around the supporting shaft 51 and the outer periphery of the fixing cover 86 is then fixed to the other side of the bracket 113 by means of the bolts 147. Here, since the air vent 56 is formed at the center of the supporting shaft 51, an end cover 88 is brought into close contact with the other side of the supporting shaft 51 by means of bolts 148 in order to close the air vent. However, if necessary, it is also possible to discharge gas or vapor produced due to increases in temperature of the reducer unit by coupling a “ [symbol] ”-shaped air discharge element (not shown) to an inner peripheral surface of the air vent 56 after separating the end cover 88.

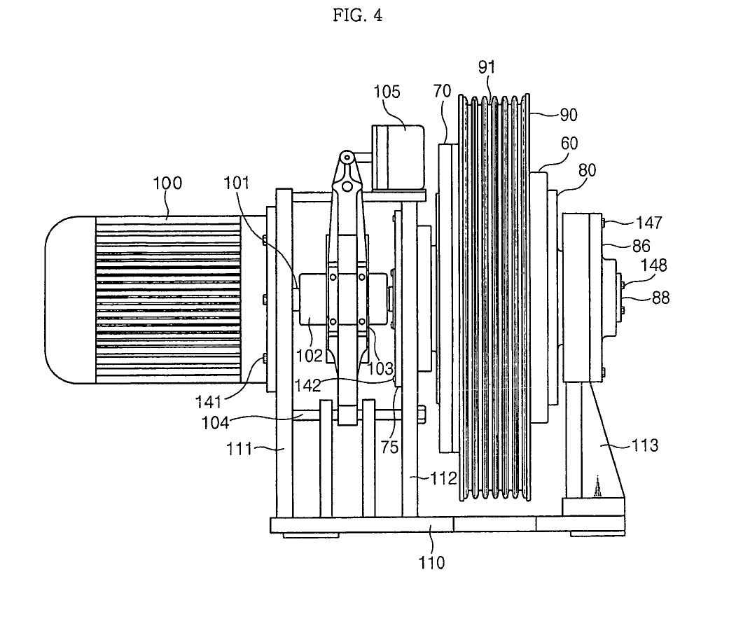

When the aforementioned components have been coupled to one another in the order described above, the elevator traction machine 1 shown in FIG. 4 is completed.

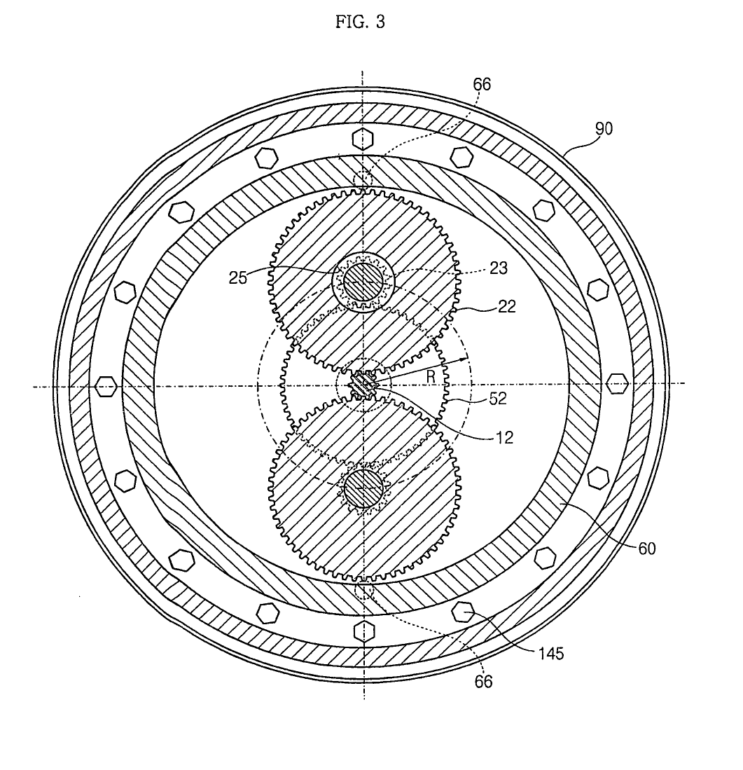

FIG. 3 is a sectional view showing a gear engagement state taken along line A-A of FIG. 2. There is shown an engagement state in which the first sun gear 12, the planetary gears 22, the planetary pinions 23 and the second sun gear 52 constituting the reducer unit of the elevator traction machine 1 according to the first embodiment of the present invention are circumscribed and engaged with one another.

As shown in FIG. 3, the planetary gears 22 are circumscribed and engaged with the first sun gear 12 to rotate and simultaneously revolve around the first sun gear along a circumference with the radius R, and the second sun gear 52 is stationary while being circumscribed and engaged with the planetary pinions 23 concentric with the planetary gears 22. Therefore, as the first sun gear 12 rotates, the planetary gears 22 rotate according to the rotation of the first sun gear 12 since the second sun gear 52 is stationary. The planetary pinions 23 revolve around the second sun gear 52.

A reduction ratio i of the gears engaged as shown in FIG. 3 is obtained as a ratio of multiplication of the numbers of teeth of driving gears to multiplication of the numbers of teeth of driven gears. Here, when a reduction ratio is calculated with actual values, the following reduction ratio can be obtained.

For example, if the numbers of teeth of the first sun gear 12 and the planetary pinion 23, which serve as driving gears, are 14 and 19, respectively, and the numbers of teeth of the planetary gear 12 and the second sun gear 52, which serve as driven gears, are 112 and 67, respectively, a reduction ratio i of 1:1/28.2 can be obtained from the following equation:

$$\begin{matrix}i = \frac{Multiplication of the numbers of teeth of driving gears}{Multiplication of the numbers of teeth of driven gears} \\ = \frac{\begin{matrix}The number of teeth of first sun gear \times \\ The number of teeth of planetary pinion\end{matrix}}{\begin{matrix}The number of teeth of planetary gear \times \\ The number of teeth of second sun gear\end{matrix}} \\ = \frac{14 \times 19}{112 \times 67} \approx \frac{1}{28.2}\end{matrix}$$

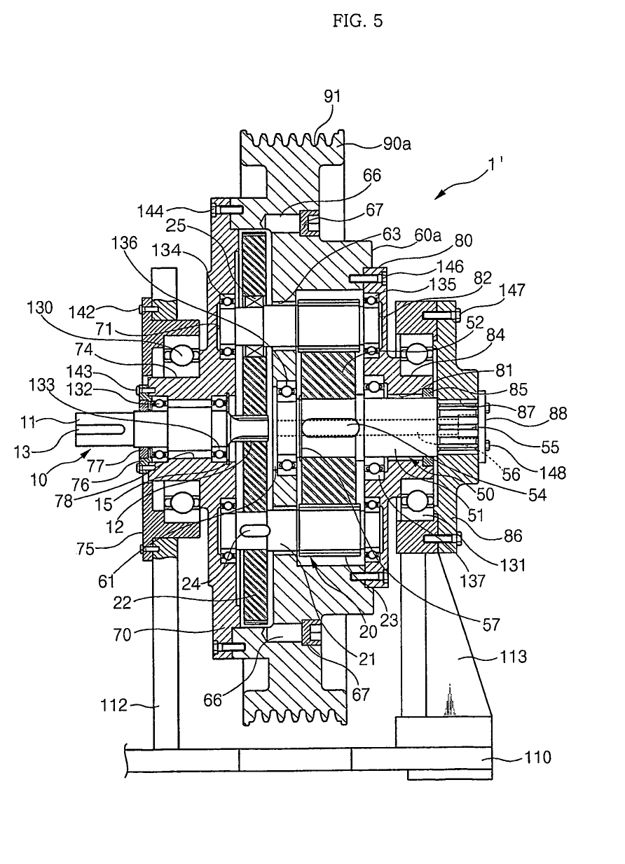

FIG. 5 is a sectional view showing an assembled state of an elevator traction machine 1′ according to a second embodiment of the present invention.

The elevator traction machine 1′ according to the second embodiment of the present invention is the same as the elevator traction machine 1 of the first embodiment in view of their components and coupling state thereof only except that a sheave 90a is formed integrally with an outer periphery of a flange 60a. Therefore, a detailed description thereof will be omitted.

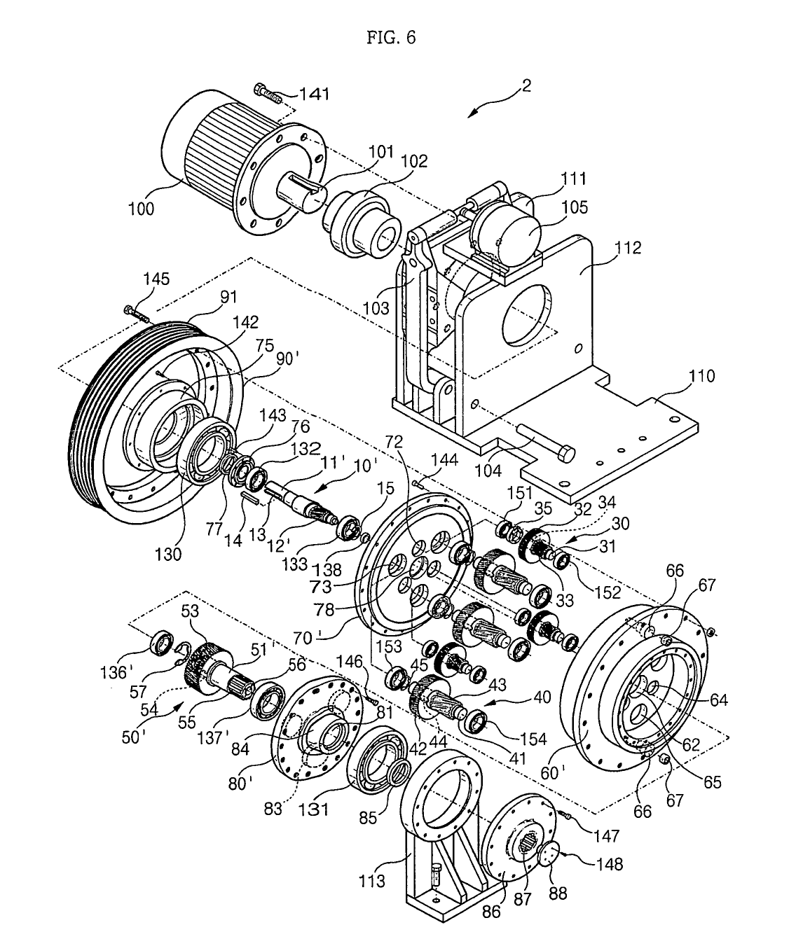

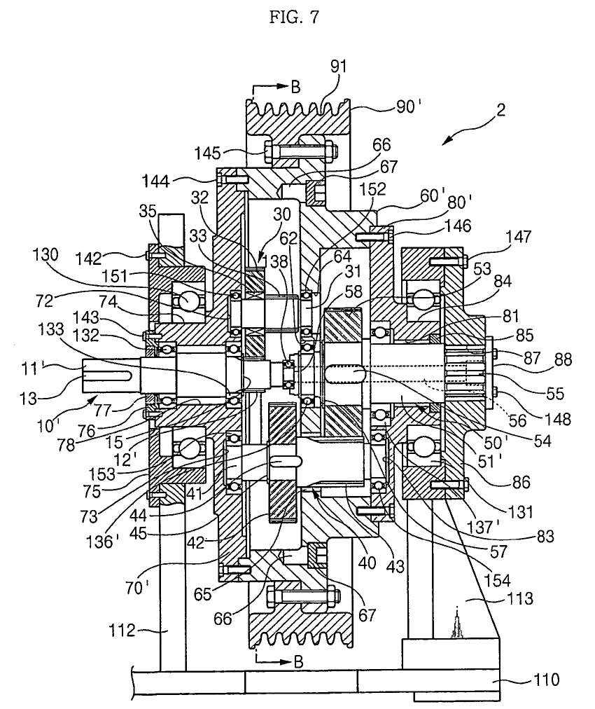

FIGS. 6 to 7 are an exploded perspective view, a sectional view showing an assembled state, and a sectional view showing a gear engagement state in an elevator traction machine according to a third embodiment of the present invention, respectively.

The elevator traction machine 2 according to the third embodiment of the present invention comprises a driving unit, a braking unit, a reducer unit, a rotating unit, a sheave 90′ and a supporting unit. Particularly, the reducer unit is constructed such that the sheave 90′ can be rotated while three-stage speed reduction is achieved by means of a gear ratio among sun gears 12′ and 53, planetary gears 32 and 42 and pinions 33 and 43.

The driving unit is adapted to transmit a driving force from a driving motor 100 to a transmission unit, and comprises a driving shaft 101 of the driving motor 100 and a driven gear 10′ coupled to the driving shaft 101. A driven shaft 11′ of the driven gear 10′ is formed, at the other end thereof, with a first sun gear 12 to be engaged with the plurality of gears constituting the reducer unit.

The braking unit comprises a brake drum 102 in the form of a coupling for connecting the driving shaft 101 to one end of the driven shaft 11′, and block brakes 103 for controlling a rotational motion while coming into close contact with the outer peripheral surface of the brake drum 102. The block brakes 103 are mechanically connected to a general hydraulic device 105 and general brake shoes.

The reducer unit is to reduce the rotational speed of the driven gear 10′ rotating at high speed and to rotate the sheave 90′ at low speed. In the reducer unit, the driven gear 10′, a plurality of transmission gears 30 and 40 and a fixed gear 50′ are engaged with one another in a state where they are circumscribed with one another. Specifically, the planetary gear 32 of each of one or more first transmission gears 30 is rotated while being circumscribed and engaged with the first sun gear 12′ of the driven gear 10′. The second planetary gear 42 of each of the second transmission gears 40 is rotated while being circumscribed and engaged with the second planetary pinion 33 of the first transmission gear 30. The third sun gear 53 of the fixed gear 50′ is fixed in a state where it is circumscribed and engaged with the third planetary pinions 43 of the second transmission gears 40. A spline 55 of the fixed gear 50′ is fixedly inserted into a spline hole 87 formed at the center of a fixing cover 86 attached to a bracket 113.

The rotating unit is to rotate a one-side cover 70 and an other-side cover 80 as the first and second planetary gears 32 and 42 revolve, and simultaneously to rotate a flange 60′ interposed between and coupled to the covers 70 and 80. In the rotating unit, a supporting shaft 51′ of the fixed gear 50′ penetrates through and is supported at the center of the flange 60′, and first and second planetary gear shafts 31 and 41 penetrate through and are supported at circumferential portions with first and second radii R1 and R2 in the flange 60′, respectively. The driven shaft 11′ of the driven gear 10′ penetrates through and is supported by the cover 70′, and one end of each of the first and second planetary gear shafts 31 and 41 is inserted into and fixed to the cover 70′. The other end of the supporting shaft 51′ penetrates through and is fixed to the cover 80′, and the other ends of the second planetary gear shafts 41 is also inserted into and fixed to the cover 80′.

The sheave 90′ is formed to be coupled to an outer periphery of the flange 60′, and an outer peripheral surface of the sheave is provided with rope grooves 91 in which wire ropes are caught.

The supporting unit is to fixedly support the driving unit, the braking unit and the rotating unit with a plurality of brackets 111, 112 and 113 and bearings 130 to 133, 136′, 137′, and 151 to 154.

The respective components of the elevator traction machine 2 according to the third embodiment of the present invention will be described below with reference to FIG. 6.

A general motor capable of reversibly rotating according to switching of electrodes is used for the driving motor 100. The driving motor 100 is fixed to the bracket 111 vertically formed at a side of a base 110 by using bolts 141 that penetrate through holes of a flange integrally formed at a front end of the driving motor. The driving shaft 101 of the driving motor 100 is coupled to the brake drum 102 in the form of a coupling by inserting a key into a keyway formed at an outer peripheral surface of the driving shaft 101.

On both sides of the outer peripheral surface of the brake drum 102, the brake shoes (brake blocks) that are braking means of the general block brakes 103 are hingedly fixed at their lower ends using pins 104, so that the brakes shoes (not shown) come into close contact with the brake drum 102 to perform the control and braking of a rotational motion according to an operation of the hydraulic device 105.

The driven shaft 11′ to be connected to the other end of the brake drum 102 is formed with a keyway 13 on an outer peripheral surface of one end thereof to establish the connection thereof to the brake drum 102. The driven shaft is coupled integrally to the brake drum by inserting a key 14 into the keyway 13. The other end of the driven shaft 11′ is formed with the first sun gear 12′ to be rotated while being engaged with the first planetary gears 32 of the first transmission gears 30.

The driven gear 10′ connected to the driving shaft 101 of the driving motor 100 is rotated in a state where the driven shaft 11′ is inserted into a driven-shaft hole 78 formed at the center of the cover 70′ and both ends of the driven shaft are supported by the bearings 132 and 133. Outside the bearing 133 coupled to the other side of the driven shaft 11′ of the driven gear 10′, a snap ring 15 is in close contact with an inner peripheral surface of the driven-shaft hole 78 to prevent the driven shaft 11′ from advancing due to thrust of the first sun gear 12′ upon rotation of the driven shaft 11′.

In each of the first transmission gears 30 that revolves along a circumference with the first radius R1 around the driven shaft 11′ of the driven gear 10′ while rotating through engagement with the driven gear 10′, the first planetary gear 32 is coupled to an outer peripheral surface at one side of the first planetary gear shaft 31 using a key 34 or a power lock 35 such that the first planetary gear is circumscribed with the first sun gear 12′ of the driven gear 10′. The second planetary pinion 33 is formed on an outer peripheral surface at the other side of the first planetary gear shaft 31. Further, in each of the second transmission gears 40 that revolves along a circumference with the second radius R2 around the driven shaft 11′ of the driven gear 10′ while rotating through engagement with the driven gear 10′, the second planetary gear 42 is coupled to an outer peripheral surface at one side of the second planetary gear shaft 41 using a key 44 such that the second planetary gear is circumscribed with the second planetary pinions 33. The third planetary pinion 43 is formed on an outer peripheral surface at the other side of the second planetary gear shaft 41.

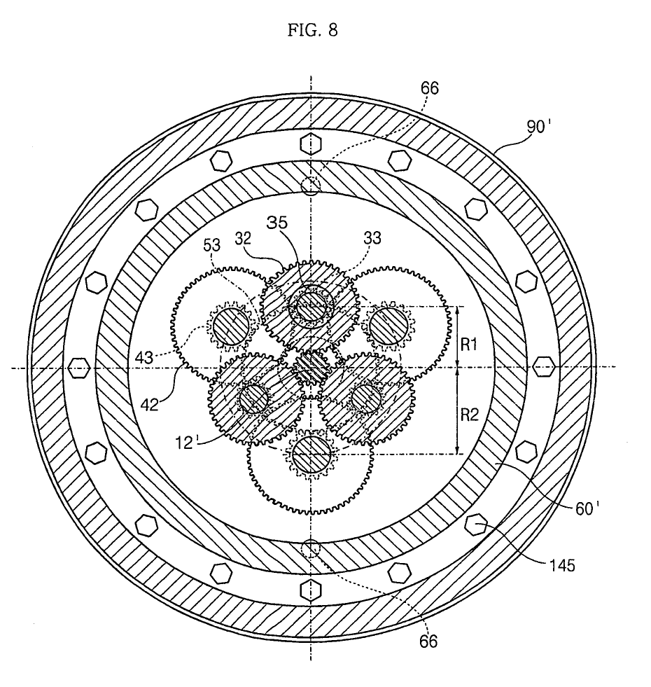

In case of the elevator traction machine 2 according to the third embodiment of the present invention, three first planetary gears 32 are positioned circumferentially at an angular interval of 120 degrees while being spaced apart by the first radius R1 from the driven shaft 11′. Further, three second planetary gears 42 are positioned circumferentially at an angular interval of 120 degrees while being spaced apart by the second radius R2 from the driven shaft 11′. Here, the second planetary gears are placed at positions rotated by 60 degrees about the driven shaft 11′ with respect to the first planetary gears 32 such that the first and second planetary gears 32 and 42 are equiangularly positioned at an angular interval of 60 degrees as shown in FIG. 8.

Each of the first planetary gear shafts 31 is rotated in a state where one end thereof is inserted into a first planetary gear shaft recess 72 formed in the cover 70′ and is supported by the bearing 151, and the other end thereof is inserted into a first planetary gear shaft hole 64 formed in the flange 60′ and is supported by the bearing 152. The second planetary gear shaft 41 is rotated in a state where both ends thereof are inserted into second planetary gear shaft recesses 73 and 83 formed in the covers 70′ and 80′ and are supported by the bearings 153 and 154 in the recesses. The second planetary gear shaft 41 between the second planetary gear 42 and the third planetary pinion 43 penetrates through and is disposed in a second planetary gear shaft hole 65 formed in the flange 60′ so that the flange 60′ can be rotated together therewith upon revolution of the first and second planetary gear shafts 31 and 41. Here, the power lock 35 is interposed between the first planetary gear shaft 31 and the first planetary gear 32 to ensure precise alignment of the engagement of the first sun gear 12′ with the first planetary gear 32 in a state where the first sun gear 12′ is placed. When teeth of the second planetary pinion 33 of each of the first transmission gears 30 are exactly engaged with teeth of the gears 42, 43 and 53, which are sequentially engaged with one another, by adjusting the first planetary gear shaft 31, the power lock 35 coupled to the first planetary gear shaft is expanded so that the first planetary gear 32 can be firmly coupled to the first planetary gear shaft 31.

Further, the third sun gear 53 of the fixed gear 50′ that is engaged with the second transmission gear 40 in a stationary state to revolve the second transmission gear 40 is coupled through a key 54 to an outer peripheral surface of one end of the supporting shaft 51′ so that the third sun gear 53 is circumscribed with the third planetary pinion 43 of the second transmission gear 40. A snap ring 57 is coupled to one side of the third sun gear 53 to prevent the third sun gear 53 from escaping in a direction of the one side due to thrust upon rotation thereof. One end of the supporting shaft 51′ is formed with a shaft recess 58 into which the other end of the driven shaft 11′ will be inserted to be horizontally supported by the bearing 138. The spline 55 is formed on an outer peripheral surface of the other end of the supporting shaft 51′, and an air vent 56 is formed to axially penetrate through a central portion of the supporting shaft 51′ in order to discharge gas or vapor produced due to increases in temperature of the reducer unit or inject a lubricant. A portion just before an outlet of the air vent 56 is formed with female threads for engagement of an additional air-discharging element (not shown). The one end of the supporting shaft 51′ is rotated in a state where it is inserted into a supporting-shaft hole 62 of the flange 60′ and supported by the bearing 136′ therein. The other side of the supporting shaft 51′ with respect to the third sun gear 53 penetrates through a fixed-gear shaft hole 81 formed at the center of the cover 80′ and is supported by the bearing 137′ therein.

Further, a fixing cover 86 for fixing the spline 55 formed at the other end of the supporting shaft 51′ to revolve the third planetary pinion 43 that is circumscribed and engaged with the third sun gear 53 is formed, at the center thereof, with the spline hole 87 into which the spline 55 is inserted. A plurality of holes are circumferentially formed along an outer periphery of the fixing cover 86 so that the fixing cover 86 is fixed to the other side of the bracket 113 by means of bolts 147.

The flange 60′ through which the second planetary gear shaft 41 of the second transmission gear 40 penetrates and which rotates upon revolution of the second planetary gear shaft 41 has the supporting-shaft hole 62 formed at the center thereof so that the one end of the supporting shaft 51′ is inserted into the supporting-shaft hole and supported by the bearing 136′ therein. Three first planetary gear shaft holes 64 through which the first planetary gear shafts 31 penetrate are formed at positions spaced apart by the first radius R1 from the center of the flange 60′ and circumferentially spaced apart at an interval of 120 degrees. Three second planetary gear shaft holes 65 through which the second planetary gear shafts 41 penetrate are formed at positions spaced apart by the second radius R2 from the center of the flange 60′ and rotated through 60 degrees with respect to the first planetary gear shaft holes 64. Therefore, the flange 60′ has the supporting-shaft hole 62 for receiving the supporting shaft 51′ at the center thereof, the three first planetary gear shaft holes 64 formed at an angular interval of 120 degrees on a circumference with the first radius R1, and the three second planetary gear shaft holes 65 formed at an angular interval of 120 degrees on a circumference with the second radius R2 and at the positions rotated through 60 degrees with respect to the first planetary gear shaft holes 64. Moreover, a plurality of holes are circumferentially formed along the outer periphery of the flange 60′ so that a side of the sheave 90′ is coupled to the flange by means of bolts 145. Upper and lower portions of the outer periphery of the flange 60′ are axially provided with oil discharge ports 66 to communicate with a space defined when the cover 70′ is coupled to the flange 60′. The oil discharge ports 66 are closed by inserting closures 67 in the form of a sunken screw thereinto.

The cover 70′ for defining a space in which the first and second planetary gears 32 and 42 revolve when the cover is coupled to the outer periphery of one side of the flange 60′ and for supporting the driven shaft 11′ penetrating through the cover is provided with a protruding boss 74 at the center of one side of the cover. The driven-shaft hole 78 is formed at the center of the boss 74 so that the driven shaft 11′ can be inserted thereinto. An inward side of the cover 70′ is formed with the three first planetary gear shaft recesses 72 into which one ends of the first planetary gear shafts 31 are inserted, at the positions spaced apart by the first radius R1 from the center thereof and circumferentially spaced apart at an interval of 120 degrees. Further, the inward side of the cover 70′ is formed with the three second planetary gear shaft recesses 73 into which one ends of the second planetary gear shafts 41 are inserted, at the positions spaced apart by the second radius R2 from the center thereof and rotated through 60 degrees with respect to the first planetary gear shaft recesses 72. A plurality of holes are circumferentially formed along an outer periphery of the cover 70′ so that the outer periphery of the one side of the flange 60′ can be coupled thereto by means of the bolts 144.

The cover 80′ for defining a space in which the third planetary pinions 43 revolve when the cover is coupled to the outer periphery of the other side of the flange 60′ and for supporting the supporting shaft 51′ penetrating through the cover is provided with a protruding boss 84 at the center of the other side of the cover. The fixed-gear shaft hole 81 is formed at the center of the boss 84 so that the supporting shaft 51′ can be inserted thereinto. An inward side of the cover 80′ is formed with the three second planetary gear shaft recesses 73 into which one ends of the second planetary gear shafts 41 are inserted, at the positions spaced apart by the second radius R2 from the center thereof and circumferentially spaced apart at an interval of 120 degrees. A plurality of holes are circumferentially formed along an outer periphery of the cover 80′ so that the outer periphery of the one side of the flange 60′ can be coupled thereto by means of the bolts 146.

The outer peripheral surface of the sheave 90′ that is integrally coupled to and rotated with the outer periphery of the flange 60′ is formed with the equidistant rope grooves 91 in which the plurality of wire ropes are caught. An outer periphery of the sheave 90′ is provided with holes into which the bolts 145 are inserted, at positions corresponding to the holes formed along the outer periphery of the flange 60′ so that the flange 60′ and the sheave 90′ can be coupled to each other by means of the bolts 145.

A process of coupling the aforementioned components to one another will be described below in greater detail with reference to FIGS. 6 and 7.

The block brakes 103 adapted to contract inwardly or expand outwardly according to the operation of the hydraulic device 105 are first disposed to face each other outside the brake drum 102 between the brackets 111 and 112 vertically formed at one side of the base 110. Then, the lower ends of the block brakes 103 are fixed by means of the pins 104, thereby completing the braking unit. In the state where the brake drum 102 is positioned between the brackets 111 and 112 formed at the one side of the base 110, the driving shaft 101 of the driving motor 100 is inserted into and coupled through the key to one side of the brake drum 102. The flange of the driving motor 100 is fixed to one side of the bracket 111 of the base 110 by means of the bolts 141.

In a state where the third sun gear 53 is coupled through the key 54 and fixed through the snap ring 57 to one side of the supporting shaft 51′, the other side of the supporting shaft 51′ is inserted into the fixed-gear shaft hole 81 formed at the center of the cover 80′ to be supported by the bearing 137′ therein. The other ends of the second planetary gear shafts 41 to which the second planetary gears 42 have not yet been coupled are inserted into the three second planetary gear shaft recesses 83 formed in the cover 80′ to be supported by the bearings 154, respectively. At this time, the three planetary pinions 43 formed at the outer peripheral surfaces of the other sides of the second planetary gear shafts 41 are placed at the positions circumferentially spaced apart at an interval of 120 degrees on the circumference with the second radius R2 and are circumscribed with the third sun gear 53 so that they can be supported parallel with the supporting shaft 51′.

When the supporting shaft and the second planetary gear shafts 41 are fixed to and supported by the cover 80′, the flange 60′ is coupled to the cover 80′. At this time, the second planetary gear shafts 41 are passed through the second planetary gear shaft holes 65 formed at the positions spaced apart by the second radius R2 from the center of the flange 60′, and the one end of the supporting shaft 51′ is inserted into the supporting-shaft hole 62 formed at the center of the flange 60′ to be supported by the bearing 136′. Then, the bolts 146 are inserted into the plurality of holes formed at the outer periphery of the cover 80′ to couple the cover 80′ to the flange 60′. At this time, the coupling of the cover 80′ to the flange 60′ defines the space therebetween in which the third planetary gears 43 revolve.

Once the flange 60′ has been coupled to the cover 80′, the second planetary gears 42 are coupled to portions of the second planetary gear shafts 41 exposed toward the one side of the flange 60′ by inserting the key 44. The other ends of the first planetary gear shafts 31 are inserted into the three first planetary gear shaft holes 64 formed at the positions spaced apart by the first radius R1 from the center of the flange 60′ and are supported by the bearings 152 therein. Two of the three first planetary gear shafts 31 have the first planetary gears 32 coupled thereto by inserting the keys 34, and the remaining one of them has the first planetary gear 32 firmly coupled thereto by interposing the power lock 35 and expanding the power lock 35 when the teeth of the second planetary pinions 33 and the second planetary gears 42, and the third planetary pinion 43 and the third sun gear 53 are exactly engaged with one another by rotating the first planetary gear shafts 31 forward or rearward.

Although the means for coupling the first planetary gears 32 to the first planetary gear shafts 31 of the first transmission gears 30 in this embodiment has been described as being the keys 34 for the coupling of the two first planetary gears 32 and the power lock 34 for the coupling of the remaining first planetary gear 32, it is not limited thereto. In coupling the first planetary gears 32 to the first planetary gear shafts 31, one of the three planetary gears 32 may be coupled by means of the key 34 and the remaining two first planetary gears 32 may be coupled by means of the power locks 35. Further, as for the means for coupling the second planetary gears 42 to the three second planetary gear shafts 41 of the second transmission gears 40, the second planetary gears 42 may be coupled to the second planetary gear shafts 41 using the key(s) 44 or the power lock(s) 35 in the same manner as the first transmission gears 30. However, this is hardly used because the second planetary gears 42 may slip on the second planetary gear shafts 41 when the second planetary gear shafts 41 are connected to the first transmission gears 30 and then subjected to large amounts of torque or rotated at high speed.

Meanwhile, the cover 70′ to be coupled to the one side of the flange 60′ that has been integrally coupled to the cover 80′ receives the driven shaft 11′ inserted into the driven-shaft hole 78 formed at the center thereof to be supported by the bearings 132 and 133. A seal holder 76 is fitted outside the bearing 132 that supports one side of the driven shaft 11′ and fixed by means of bolts 143, and an oil seal 77 is then fitted into and seated in a groove of the seal holder 76. Outside the bearing 133 supporting the other side of the driven shaft 11′, the snap ring 15 is installed at an inner peripheral surface of the driven-shaft hole 78 to prevent the driven shaft 11′ from advancing upon rotation of the driven shaft 11′.

When the driven shaft 11′ is inserted into the cover 70′, the cover 70′ is coupled to the one side of the flange 60′. At this time, the one end of each of the first and second planetary gear shafts 31 and 41 with the bearings 151 and 153 coupled to the outer peripheral surfaces thereof that are fixed to the cover 80′ and the flange 60′, respectively, is inserted into one of the three first planetary gear shaft recesses 72 and three second planetary gear shaft recesses 73 formed in the cover 70, and at the same time, the driven shaft 11′ with the bearing 138 coupled to the outer peripheral surface of the other end thereof is inserted into the shaft recess 58 formed at the one end of the supporting shaft 51′, so that all the first and second planetary gear shafts 31 and 41 and the driven shaft 11′ can be supported by the bearings 151, 153 and 138 within the first and second planetary gear shaft recesses 72 and 73 and the shaft hole 58.

When the rotating unit is completed by coupling the covers 70′ and 80′ to the both sides of the flange 60′ as described above, the sheave 90′ is integrally coupled to the outer periphery of the flange 60′ by means of the bolts 145.

A supporting cover 75 is inserted on one side of the bracket 112 into a hole of the bracket 112 vertically formed on the base 110 and is then fixed thereto using bolts 142. The bearing 130 is coupled to an outer peripheral surface of the boss 74 of the cover 70 of the rotating unit and the boss is then inserted to be in contact with an inner peripheral surface of the supporting cover 75 so that one end of the rotating unit can be supported by the bearing 130. At the same time, a portion of the driven shaft 11′ protruding toward one side of the rotating unit is inserted into the other side of the brake drum 102 and the key is fitted into the keyway formed on the outer peripheral surface of the driven shaft 11′, thereby coupling the driven shaft 11′ to the driving shaft 101.

The bearing 131 is coupled to an outer peripheral surface of the boss 84 of the cover 80′ of the rotating unit and the bracket 113 is fitted around the boss with the beating coupled thereto so that the other end of the rotating unit can be supported by the bracket. To prevent leakage of oil around the supporting shaft 51′ of the fixed gear 50′, an oil seal 85 is fitted between an inner peripheral surface of the other end of the cover 80′ and an outer peripheral surface of the supporting shaft 51′. To fix the spline 55 of the supporting shaft 51′ protruding toward the other side of the rotating unit, the fixing cover 86 formed with the spline hole 87 at the center thereof is coupled around the supporting shaft 51′ and the outer periphery of the fixing cover 86 is then fixed to the other side of the bracket 113 by means of the bolts 147. Here, since the air vent 56 is formed at the center of the supporting shaft 51′, an end cover 88 is brought into close contact with the other side of the supporting shaft 51′ by means of bolts 148 in order to close the air vent. However, if necessary, it is also possible to discharge gas or vapor produced due to increases in temperature of the reducer unit by coupling a “ [symbol] ”-shaped air discharge element (not shown) to an inner peripheral surface of the air vent 56 after separating the end cover 88.

FIG. 8 is a sectional view showing a gear engagement state taken along line B-B of FIG. 7. There is shown an engagement state in which the first sun gear 12′, the first planetary gears 32, the second planetary pinions 33, the second planetary gears 42, the third planetary pinions 43 and the third sun gear 53 constituting the reducer unit of the elevator traction machine 2 according to the third embodiment of the present invention are circumscribed and engaged with one another.

As shown in FIG. 8, the first planetary gears 32 are circumscribed and engaged with the first sun gear 12′ to rotate and simultaneously revolve around the first sun gear along the circumference with the first radius R1, the second planetary gears 42 are circumscribed and engaged with the second planetary pinions 33 concentric with the first planetary gears 32 to rotate and simultaneously revolve along the circumference with the second radius R2, and the third sun gear 53 is stationary while being circumscribed and engaged with the third planetary pinions 43 concentric with the second planetary gears 42. Therefore, as the first sun gear 12′ rotates, the first and second planetary gears 32 and 42 rotate according to the rotation of the first sun gear 12′ since the third sun gear 53 is stationary. The second and third planetary pinions 33 and 43 revolve around the third sun gear 53.

A reduction ratio i of the gears engaged as shown in FIG. 8 is obtained as a ratio of multiplication of the numbers of teeth of driving gears to multiplication of the numbers of teeth of driven gears. Here, when a reduction ratio is calculated with actual values, the following reduction ratio can be obtained.

For example, if the numbers of teeth of the first sun gear 12′, the second planetary pinion 33 and the third planetary pinion 43, which serve as driving gears, are 21, 15 and 18, respectively, and the numbers of teeth of the first planetary gear 32, the second planetary gear 42 and the third sun gear 52, which serve as driven gears, are 56, 54 and 53, respectively, a reduction ratio i of 1:1/28.2 can be obtained from the following equation:

$$\begin{matrix}i = \frac{Multiplication of the numbers of teeth of driving gears}{Multiplication of the numbers of teeth of driven gears} \\ = \frac{\begin{matrix}The number of teeth of first sun gear \times \\ The number of teeth of second planetary pinion \times \\ The number of teeth of third planetary pinion\end{matrix}}{\begin{matrix}The number of teeth of first planetary gear \times \\ The number of teeth of second planetary gear \times \\ The number of teeth of third sun gear\end{matrix}} \\ = \frac{21 \times 15 \times 18}{56 \times 54 \times 53} \approx \frac{1}{28.2} .\end{matrix}$$

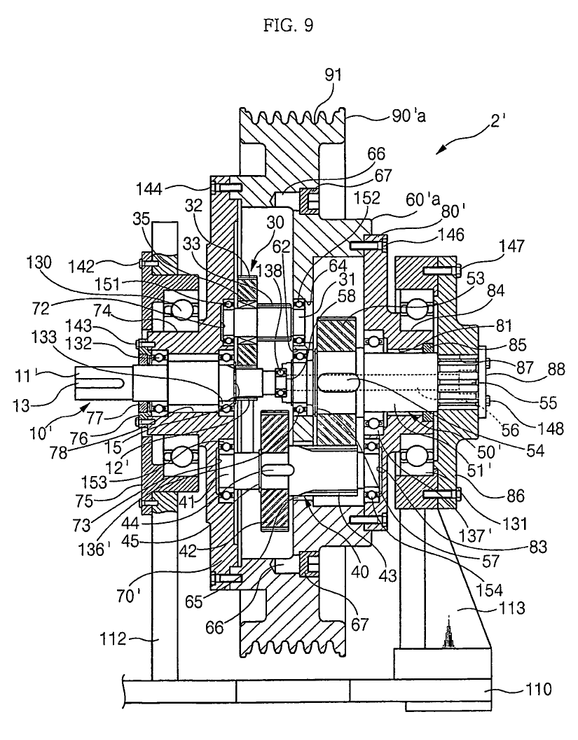

FIG. 9 is a sectional view showing an assembled state of an elevator traction machine according to a fourth embodiment of the present invention.

The elevator traction machine 2′ according to the fourth embodiment of the present invention is the same as the elevator traction machine 2 of the third embodiment in view of their components and coupling state thereof only except that a sheave 90a′ is formed integrally with an outer periphery of a flange 60a′. Therefore, a detailed description thereof will be omitted.

Although general spur gears may be used as the driven gear, the plurality of transmission gears and the fixed gear constituting the transmission unit of the elevator traction machine of the present invention described above, it is preferred that helical gears with a helix angle of 15 to 25 degrees be used for constituting the transmission unit in order to reduce noise and vibrations due to the high speed rotation of the driven shaft and to transmit a larger rotational force. To prevent the driven shaft, the planetary gear shafts and the supporting shaft from advancing or withdrawing due to generation of thrust upon rotation of the transmission unit, or to prevent the sun gears and the planetary gears, which have been engaged with the driven shaft, the planetary gear shafts and the supporting shaft, from being disengaged due to the thrust, it is preferred that helical gears formed on or coupled to the same shaft have helix angles in the same direction, and helical gears circumscribed and engaged with the above helical gears have helix angles in a direction opposite to the above direction, as shown in FIGS. 1 and 6. Further, the space defined when the flange and the covers are coupled to one another is a space not only for allowing the plurality of gears of the transmission unit to smoothly rotate or revolve therein but also for accommodating a lubricant therein to minimize a mechanical abrasion phenomenon in the transmission unit. Therefore, the oil discharge ports communicating with the space are provided at the upper and lower portions of the flange so that the lubricant can be discharged into the space. To ensure smoother discharge of the lubricant through the lower oil discharge port when the lubricant is intended to be discharged through the lower oil discharge port, it is preferred that the upper oil discharge port be used in an open state. The oil discharge ports can be hermetically closed by the closures.

The elevator traction machine of the present invention can be applied to a variety of apparatuses that can perform the function of winding or unwinding the wire ropes while reducing the rotational speed of the driving shaft by rotating the driving motor forward or rearward. Particularly, it can also be employed in apparatuses using hoists, winches, conveyor pulleys, general driving pulleys, sprockets, and the like.

As described above, the present invention provides a planetary gear-type elevator reducer unit constructed by sequentially engaging sun gears, a plurality of planetary gears and a plurality of pinions, which have the numbers of teeth thereof different from one another, with one another to rotate a rotating body and a sheave formed integrally with a one-side cover and an other-side cover while reducing high speed rotation to low speed rotation. Particularly, when the plurality of planetary gears revolve around the sun gears, planetary gear shafts and the sheave are caused to be rotated together. Further, in case of a conventional elevator traction machine using cycloid gears, vibrations and noise resulting from impact are severely produced whenever a sheave is rotated. However, in the present invention, vibrations and noise are hardly produced since the sun gears, the plurality of planetary gears and the plurality of pinions are rotated in a state where they are always engaged with one another. To transport a larger rotational force upon rotation of the gears, the sun gears, the plurality of planetary gears and the plurality of pinions are formed of helical gears that can be engaged with one another. Moreover, although the conventional elevator traction machine using the cycloid gears has a gear efficiency of about 90%, the elevator traction machine using the helical gears according to the present invention has a gear efficiency of 96% in the two-stage structure (the first and second embodiments of the present invention) and a gear efficiency of 94.1% in the three-stage structure (the third and fourth embodiments of the present invention). Thus, the elevator traction machine of the present invention can obtain a better efficiency than the conventional traction machine.

Since the elevator traction machine of the present invention is constructed of the sun gears, the plurality of planetary gears and the plurality of pinions that are installed in the state where they are sequentially engaged with one another, the structure of the elevator traction machine can be simplified. In addition, since the gears are installed within a space defined by the covers, the elevator traction machine can be manufactured compactly, thereby ensuring the more efficient use of an installation space. Furthermore, since the sun gears, the plurality of planetary gears and the plurality of pinions can be manufactured using universal gear manufacturing equipment, it is possible to reduce production costs.

1. An elevator traction machine, comprising:
a driving unit for transmitting a driving force from a driving motor (100), including a driving shaft (101) of the driving motor (100) and a driven gear (10) having a first sun gear (12) formed at the other end of a driven shaft (11) coupled to the driving shaft (101);
a braking unit including a brake drum (102) in the form of a coupling for connecting the driving shaft (101) to one end of the driven shaft (11), and block brakes (103) for controlling a rotational motion while coming into close contact with an outer peripheral surface of the brake drum (102);
a reducer unit constructed such that a planetary gear (22) of each of one or more transmission gears (20) is rotated while being circumscribed and engaged with the first sun gear (12) of the driven gear (10), a second sun gear (52) of a fixed gear (50) is stationary in a state where it is circumscribed and engaged with a planetary pinion (23) of each of the transmission gears (20), and a spline (55) of the fixed gear (50) is fixedly inserted into a spline hole (87) formed at the center of a fixing cover (86) attached to a bracket (113);
a rotating unit including a flange (60) which a supporting shaft (51) of the fixed gear (50) penetrates through and is supported by at the center thereof and which a planetary gear shaft (21) of each of the transmission gears (20) penetrates through and is supported by at a circumferential portion with a radius (R) therein, a one-side cover (70) which the driven shaft (11) of the driven gear (10) penetrates through and is supported by and which one end of the planetary gear shaft (21) is inserted into and fixed to, and an other-side cover (80) which the other end of the supporting shaft (51) of the fixed gear (50) penetrates through and is fixed to and which the other end of the planetary gear shaft (21) is inserted into and fixed to, thereby rotating the covers (70, 80) as the planetary gear (22) revolves;
a sheave (90) which is formed to be coupled to an outer periphery of the flange (60) and of which an outer peripheral surface is provided with rope grooves (91) in which wire ropes are caught; and
a supporting unit for fixedly supporting the driving unit, the braking unit and the rotating unit with a plurality of brackets (111, 112, 113) and bearings (130 to 137).

2. An elevator traction machine, comprising:
a driving unit for transmitting a driving force from a driving motor (100), including a driving shaft (101) of the driving motor (100) and a driven gear (10′) having a first sun gear (12′) formed at the other end of a driven shaft (11′) coupled to the driving shaft (101);
a braking unit including a brake drum (102) in the form of a coupling for connecting the driving shaft (101) to one end of the driven shaft (11′), and block brakes (103) for controlling a rotational motion while coming into close contact with an outer peripheral surface of the brake drum (102);
a reducer unit constructed such that a first planetary gear (32) of each of one or more first transmission gears (30) is rotated while being circumscribed and engaged with the first sun gear (12′) of the driven gear (10′), a second planetary gear (42) of each of one or more second transmission gears (40) is rotated while being circumscribed and engaged with a second planetary pinion (33) of each of the first transmission gears (30), a third sun gear (53) of a fixed gear (50′) is stationary in a state where it is circumscribed and engaged with a third planetary pinion (43) of each of the second transmission gears (40), and a spline (55) of the fixed gear (50′) is fixedly inserted into a spline hole (87) formed at the center of a fixing cover (86) attached to a bracket (113);
a rotating unit including a flange (60′) which a supporting shaft (51′) of the fixed gear (50′) penetrates through and is supported by at the center thereof, which a first planetary gear shaft (31) of each of the first transmission gears (30) penetrates through and is supported by at a circumferential portion with a first radius (R1) therein, and which a second planetary gear shaft (41) of each of the second transmission gears (40) penetrates through and is supported by at a circumferential portion with a second radius (R2) therein, a one-side cover (70′) which the driven shaft (11′) of the driven gear (10′) penetrates through and is supported by, which one end of the first planetary gear shaft (31) is inserted into and fixed to, and which one end of the second planetary gear shaft (41) is inserted into and fixed to, and an other-side cover (80′) which the other end of the supporting shaft (51′) of the fixed gear (50′) penetrates through and is fixed to and which the other end of the second planetary gear shaft (41) is inserted into and fixed to, thereby rotating the covers (70′, 80′) as the planetary gears (32, 42) revolve;
a sheave (90′) which is formed to be coupled to an outer periphery of the flange (60′) and of which an outer peripheral surface is provided with rope grooves (91) in which wire ropes are caught; and
a supporting unit for fixedly supporting the driving unit, the braking unit and the rotating unit with a plurality of brackets (111, 112, 113) and bearings (130 to 133, 136′, 137′, 138, 151 to 154).

3. The elevator traction machine as claimed in claim 1, wherein an inward side of the cover (70) is formed on a circumference with the radius (R) with a planetary gear shaft recess (71) into which one end of the planetary gear shaft (21) is inserted, and at the center thereof with a driven-shaft hole (78) through which the one end of the driven shaft (11) penetrates; and an inward side of the cover (80) is formed on a circumference with the radius (R) with a planetary gear shaft recess (82) into which the other end of the planetary gear shaft (21) is inserted, and at the center thereof with a fixed-gear shaft hole (81) through which the other end of the supporting shaft (51) penetrates.

4. The elevator traction machine as claimed in claim 2, wherein an inward side of the cover (70′) is formed on circumferences with the first and second radii (R1, R2) with first and second planetary gear shaft recesses (72, 73) into which one ends of the first and second planetary gear shafts (31, 41) are inserted, and at the center thereof with a driven-shaft hole (78) through which the one end of the driven shaft (11′) penetrates; and an inward side of the cover (80′) is formed on a circumference with the second radius (R2) with a second planetary gear shaft recess (83) into which the other end of the second planetary gear shaft (41) is inserted, and at the center thereof with a fixed-gear shaft hole (81) through which the other end of the supporting shaft (51′) of the fixed gear penetrates.

5. The elevator traction machine as claimed in claim 1 or 2, wherein the sheave (90; 90′) is formed integrally with the outer periphery of the flange (60; 60′).

6. The elevator traction machine as claimed in claim 1, wherein the planetary gear (22) is coupled to an outer peripheral surface of one side of the planetary gear shaft (21) by means of a key (24), and the planetary pinion (23) is formed on an outer peripheral surface of the other side of the planetary gear shaft.

7. The elevator traction machine as claimed in claim 2, wherein the first planetary gear (32) is coupled to an outer peripheral surface of one side of the first planetary gear shaft (31) by means of a key (34), and the second planetary pinion (33) is formed on an outer peripheral surface of the other side of the first planetary gear shaft; and the second planetary gear (42) is coupled to an outer peripheral surface of one side of the second planetary gear shaft (41) by means of a key (44), and the third planetary pinion (43) is formed on an outer peripheral surface of the other side of the second planetary gear shaft.

8. The elevator traction machine as claimed in claim 1, wherein the planetary gear (22) is coupled to one side of the planetary gear shaft (21) of one of the transmission gears (20) by means of a power lock (25).

9. The elevator traction machine as claimed in claim 2, wherein the first planetary gear (32) is coupled to one side of the first planetary gear shaft (31) of one of the first transmission gears (30) by means of a power lock (35).

10. The elevator traction machine as claimed in claim 1 or 2, wherein the driven gear (10; 10′), the planetary gear(s) (20; 30, 40) and the fixed gear (50; 50′) are formed of helical gears with a helix angle of 15 to 25 degrees.
